(19) United States
(12) Patent Application Publication
(10) Pub. No.: US 2009/0222286 A1
(43) Pub. Date: Sep. 3, 2009

(54) EVENT-MARKED, BAR-CONFIGURED TIMELINE DISPLAY FOR GRAPHICAL USER INTERFACE DISPLAYING PATIEN'TS MEDICAL HISTORY

(75) Inventor: John F. Elsholz, Sandy, UT (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,666

(22) PCT Filed: Dec. 8, 2006
(86) PCT No.: PCT/IB2006/054715

§ 371 Date: Feb. 2, 2009

Related U.S. Application Data
(60) Provisional application No. 60/748,413, filed on Dec. 8, 2005.

(51) Int. Cl. G06Q 50/00; G06F 3/048

(52) U.S. Cl. 705/3; 715/777; 707/100; 707/1; 715/781

(57) ABSTRACT

One can display a patient's medical history on a (color-coded), bar-configured chronological timeline. The patient timeline display includes event markers that are located adjacent to specific time increments along the patient timeline when the patient had certain procedures performed. Namely, each procedure is represented by an event marker referenced to its time of performance along the timeline. From the basic bar-configured timeline which contains a pop-up bubble, the physician can see at a glance every major hospital encounter a particular patient has had over the duration of the timeline, e.g., the last 12-months.

This application claims the benefit of U.S. Provisional Application Ser. No. 60/748,413, filed Dec. 8, 2005, which is incorporated in whole by reference.

### FIELD OF THE INVENTION

The present invention relates, in general, to medical information storage and retrieval systems, and is particularly directed to a bar-configured timeline display for a graphical user interface, that displays information representative of a patient's medical history, in the form of condensed-text, event markers or descriptors, that are referenced to, or marked along, the time increments (e.g., particular months) into which the displayed timeline has been divided. Such a patient timeline display allows a physician to see at a glance every major hospital encounter a particular patient has had over the duration of the timeline, e.g. twelve months.

### BACKGROUND OF THE INVENTION

Cardiovascular information systems present historical data about patients to clinicians who wish to compare current diagnostic tests with prior studies, in order to observe the progression of various disease states. Thus, a cardiologist who has performed an echocardiogram on a patient may wish to pull up an EKG or echo that was done on the same patient six-months or a year ago, in order to determine if the patient's valves have thickened, septal walls have thickened, an aneurysm has deteriorated, and the like. This provides the clinician with a more holistic view of the patient's pathology and associated comorbidities.

To this end, CVIIS manufacturers display a patient directory that allows the user to search for patients and review their procedures. Some of systems link patients to their other procedures to allow rapid navigation between studies. Conventional CVIIS manufacturers typically present historical studies in a tree diagram, like, or similar to, the Microsoft Explorer tree diagram of in FIG. 1A. As shown therein, the tree diagram has a top icon that represents a folder containing the patient's name, here identified as one Ben J. Anderson. Branched beneath the patient name folder is a separate folder for each different type of procedure, such as a cath, echo, EP, etc. In order to review all of the EKG's that have been performed on this patient, the user must click on or involve the EKG folder icon, which opens to the EKG folder and allows the user to see the dates of all of the EKG studies. The user must then click on the EKG study folder to actually see each EKG study it contains. However, even with a specific EKG study open, the user is unable to see the dates or progression of disease. Some existing prior art systems present thumbnails of studies along the margin or bottom of the screen with a procedure date. However, this is counter-intuitive for the physician, and still does not present a snapshot of the patient's history in one place.

### SUMMARY OF THE INVENTION

The present invention effectively overcomes these and other shortcomings of prior art patient information display systems, by displaying a patient's medical history on a (color-coded), bar-configured chronological timeline, such as that depicted in the left middle portion of the graphical user interface shown in FIG. 1. The patient timeline display includes event markers that are located adjacent to specific time increments along the patient timeline when the patient had certain procedures performed. Namely, each procedure is represented by an event marker referenced to its time of performance along the timeline. From the basic bar-configured timeline shown in FIG. 1, and also in FIG. 2, which contains a pop-up bubble, the physician can see at a glance every major hospital encounter a particular patient has had over the duration of the timeline, e.g., the last 12-months.

As will be described in the sub-paragraphs of Section 2., “Overall Description”, and the sub-paragraphs of Section 3., “Details”, set forth below, by clicking on various portions of the screen that is displayed to the clinician, the displayed patient timeline information can be expanded, from simply presenting dates, to more detailed information as to what was performed on a specific date, as well as results and recommendations relating to the particular procedure.

### BRIEF DESCRIPTION OF THE DRAWINGS

FIG. 1A shows a computer workstation screen display of a tree diagram of folders of an historical record of medical procedures performed on a particular patient;

FIG. 1 shows a graphical user interface displayed by the display screen of a computer workstation through which patient medical history information is accessed using the bar-configured patient timeline of the present invention;

FIG. 2 shows the graphical user interface of FIG. 1, wherein the patient timeline display of FIG. 1 has been augmented by the display of additional information within a pop-up bubble that is generated by invoking a selected event marker along the patient timeline;

FIG. 3 shows a graphical user interface displayed by the display screen of a computer workstation through which patient medical history information is accessed using the patient timeline of the invention, and depicting a procedure report review screen containing tabs, that group available information into different categories, and particularly displaying a window containing text and imagery data within a procedure report, that has been accessed by invoking the “report” tab;

FIG. 4 shows a graphical user interface displayed by the display screen of a computer workstation through which patient medical history information is accessed using the patient timeline of the invention, and depicting a window containing waveforms and hemodynamic information that has bee accessed by invoking the “hemo” tab of the window displayed within the screen shown in FIG. 3.

### 2. OVERALL DESCRIPTION

2.1 Patient Timeline Perspective

The patient timeline display mechanism of the present invention provides additional functionality to the more traditional patient directory. In particular, the patient timeline display mechanism of the invention is able to query databases, including the hospital database, modalities or PACS it has current interfaces with, and the RHIO directory, and is operative to display the patient's Medicare (e.g., cardiac) procedures and other pertinent medical records in a bar-configured timeline. This serves to provide a visual overview of the patient's medical history, so that the user can see germane patient information at a glance. The patient timeline of the invention therefore provides a very visual and user-friendly scheme for navigating through patient lists, as well as viewing and accessing their electronic health records.

2.2 Patient Timeline Functions

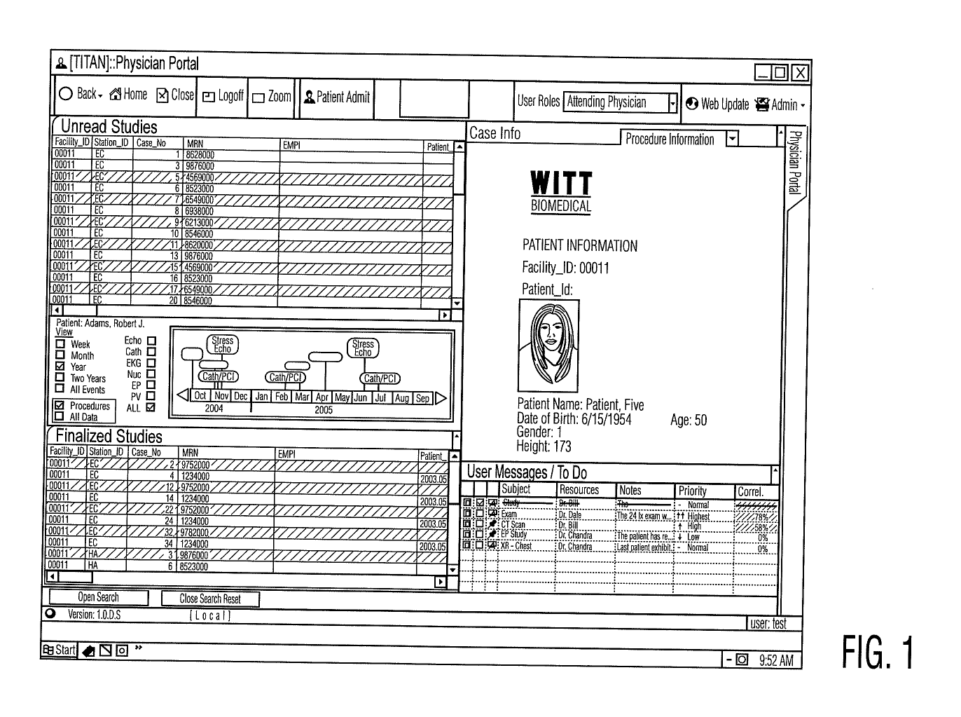

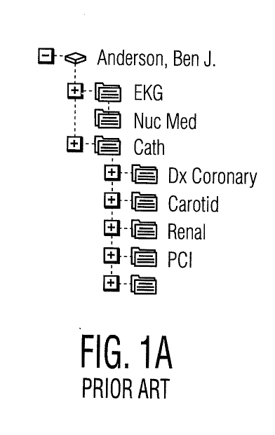

When the user puts focus on a patient in one of the patient lists (i.e. Unread Studies, Finalize Studies, or Consults), as displayed by a graphical user interface (GUI) on the display monitor of the user's workstation, the patient timeline of the invention is invoked. The time period being viewed is selectable by the user, in lengths of time ranging from one week up to the entire time period records have been kept for that patient, but the default setting is preferably for the prior twelve month window, as shown in FIG. 1. Procedures and other records available for the patient, such as labs and ECGs, are displayed by way of event markers inserted at appropriate locations along the timeline, using procedure-related color coding. Mousing over one of the event markers causes a bubble-window to pop-up adjacent to and referencing the selected event marker. The bubble window typically contains a number of pertinent pieces of information relating to the selected procedure, including, but not limited to, the date and type of procedure, the performing physician, a brief conclusion, and recommendations, if appropriate. Double-clicking on the event marker opens a procedure results window containing tabs that are used to separate procedure-related information into different categories, such as Labs, Procedure Log, Reports, etc. Invoking one of these tabs causes information that has been stored for a particular category to be displayed.

### 3. DETAILS

3.1 Timeline Basic Description

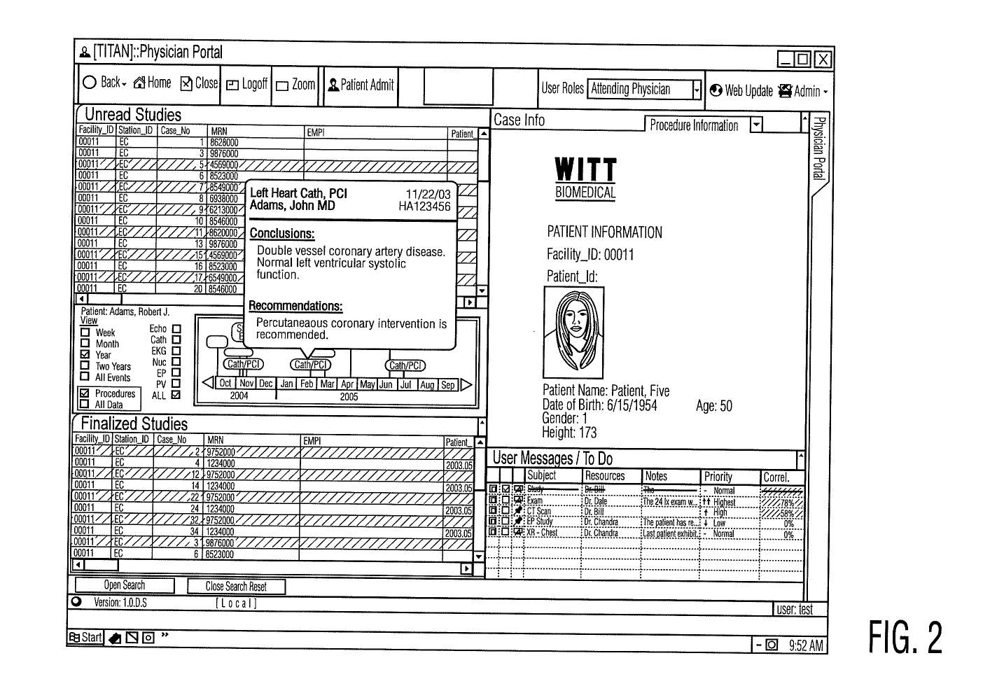

The patient timeline is a visual representation of a patient's medical record, allowing the user to see the patient's pertinent information at a glance. It is organized so that time periods are easily distinguishable. It is centrally located between Unread Studies and Finalized Studies on the Physician's Home Page, and at the bottom of the Patient List for other users.
3.1.1. Function: To view a patient's medical (e.g., cardiac) procedures and other records at a glance (see FIG. 1).
   3.1.1.1 Cardiac procedures
   3.1.1.2 History and Physical
   3.1.1.3 Radiology procedures
   3.1.1.4 Labs
   3.1.1.5 ECGs
   3.1.1.6 Hospital admissions
   3.1.1.7 Reports
3.1.2 Function: The patient timeline has a permanent location on the GUI.
   3.1.2.1 For physician users, it is located between Unread Studies and Finalized Studies on the Physician Home Page.
   3.1.2.2 For other users, it is located at the bottom of the Patient List.
3.1.3 Function: The patient timeline is divided into easy-to-read time periods (month, year, etc.).
   3.1.3.1 The patient timeline has an easy-to-read appearance, regardless of the number of patient events.
   3.1.3.2 Other than for cardiac procedures, the timeline has only one event marker for each type of event per week (e.g. labs).
      3.1.3.2.1 If more than one occurrence of the same event occurs in a week (e.g. ECGs), only the most recent event is displayed.
         3.1.3.2.1.1 The number of occurrences for this type of event is displayed in parentheses after the label; i.e., ECG (5).
      3.1.3.2.2 Single-clicking one of the time increments of the patient timeline bar expands the timescale, such that the increment clicked will expand to full scale, and will show each event within that time increment and the date of the procedure. In other words, if the scale is twelve months, clicking one of the month increments (e.g. June) will expand the month of June to full scale. This is valuable for cases where the patient has had many procedures during one admit.
3.1.4 Function: Ability to easily identify year
   3.1.4.1 Year(s) are displayed prominently beneath the patient timeline
   3.1.4.2 A heavy vertical line extends through the patient timeline to separate years
3.1.5 Function: Ability to distinguish between procedures based on color coding
   3.1.5.1 Procedures and other events are preferably displayed using color-coded event markers
      3.1.5.1.1 Cath/PCI—yellow
      3.1.5.1.2 CABG—red
      3.1.5.1.3 Echo—light green
      3.1.5.1.4 ECG—purple
      3.1.5.1.5 Nuclear cardiology—royal blue
      3.1.5.1.6 EP—orange
      3.1.5.1.7 PV/NIPV—dark green
      3.1.5.1.8 Labs—tan
      3.1.5.1.9 X-ray—gray
      3.1.5.1.10 CT, MR, PET—navy blue
      3.1.5.1.11 ED visit—teal
      3.1.5.1.12 Medications—lavender
      3.1.5.1.13 H & P—light blue
      3.1.5.1.14 Other—white
   3.1.5.2 A vertical line connects an event marker to its appropriate location along the patient timeline, as shown in FIGS. 1 and 2
3.1.6 Function: Only one patient timeline can be open at a time (if a physician changes focus to another patient, the displayed patient timeline data automatically changes to show the new patient's information)
3.1.7 Function: Ability to automatically update patient information on the patient timeline when it is invoked
   3.1.7.1 The interface retrieves any new information available in the HIS/RIS/PACS/Modality/RHIO and places it in a temporary folder in the system database
      3.1.7.1.1 The temporary folder is deleted when the user logs out
   3.1.7.2 When invoked, the patient timeline will query the system database for up-to-date patient records
3.1.8 Function: Ability to manually update the patient timeline
   3.1.8.1 An Update button in the upper right corner of the patient timeline window sends a command for the interface to look for updated patient information in the HIS/RIS/PACS/Modality/RHIO, which responds by presenting a list of sources of data to the user, who can select the one(s) of interest, and import it into the temporary folder in the system database. The patient timeline will then be able to include the information in the patient timeline.

3.2 Retrieving EMR Data To Be Incorporated Into The Patient Timeline

When a patient is scheduled or admitted, a search engine is invoked, which will query the system database for relevant data. All pertinent patient events within the system database are displayed along the patient timeline using color-coded event markers, as described in 3.1.5. An event marker is labeled with the event type (e.g. Echo, ECG, Labs) and is referenced to the date of the event, as shown in FIG. 1.

If the facility uses EMRs, the interface will search the HIS, RIS, PACS, and modalities such as MUSE, EnConcert, and TraceMaster for patient events and if possible, place that information in a temporary folder for use in the patient timeline. After data from the other sources is placed inside the temporary folder, the data will be instantly displayed on the patient timeline without making further queries when the user puts focus on a patient. The hospital's interface must be able to send this information to the system, in order for the HIS/PACS/Modality/RIS portion of the patient timeline to be available for system users.
3.2.1 Function: Ability to locate the patient's relevant health records
   3.2.1.1 From the system database
      3.2.1.1.1 Locates All Procedures
      3.2.1.1.2 Locates Reports
      3.2.1.1.3 Locates Labs
      3.2.1.1.4 Locates History and Physical
      3.2.1.1.5 Is prepared to display data on the patient timeline using color-coded event markers, as defined in 3.1.5
   3.2.1.2 From other data sources.
      3.2.1.2.1 Data elements that will be available to extract events:
         3.2.1.2.1.1 Labs
         3.2.1.2.1.2 Medications
         3.2.1.2.1.3 Admissions
      3.2.1.2.2 Additional data elements available to extract events:
         3.2.1.2.2.1 Procedures
         3.2.1.2.2.2 Reports
         3.2.1.2.2.3 History and Physical
         3.2.1.2.2.4 Emergency Department visits
         3.2.1.2.2.5 Orders
         3.2.1.2.2.6 Required procedural information from other sources is supplied by those sources.
   3.2.1.3 Within a RHIO
      3.2.1.3.1 The system obtains data from RHIOs by querying all connected information systems in the RHIO, using patient identifiers.
3.2.2 Function: Ability to display desired data in the patient timeline using filters
   3.2.2.1 Filters are activated by check boxes located at the bottom left of patient timeline window
   3.2.2.2 Filter 1: “Procedures”
      3.2.2.2.1 From the system database:
         3.2.2.2.1.1 Displays event markers for all procedures found in the system database
         3.2.2.2.1.2 Displays HIS/RIS procedures if they have been imported to the temporary folder in the system database
      3.2.2.2.2 From HIS or RIS:
         3.2.2.2.2.1 No information will be available for procedures located outside the system database
   3.2.2.3 Filter 2: “All Data”
      3.2.2.3.1 From system database:
         3.2.2.3.1.1 Displays labs
         3.2.2.3.1.2 Displays medications
         3.2.2.3.1.3 Displays ECGs
         3.2.2.3.1.4 Displays History and Physical
         3.2.2.3.1.5 Displays Emergency Department visits
         3.2.2.3.1.6 Displays admissions
      3.2.2.3.2 From HIS or RIS:
         3.2.2.3.2.1 Displays HIS/RIS events if they have been imported to the temporary folder in the system database
         3.2.2.3.2.2 Labs—the entire lab report will be imported as an object
         3.2.2.3.2.3 Medications
         3.2.2.3.2.4 ECGs
         3.2.2.3.2.5 History and Physical
         3.2.2.3.2.6 Reports
         3.2.2.3.2.7 Office Visits—office information is available to the system only if a RHIO has been implemented
         3.2.2.3.2.8 Emergency Department visits

3.3 Invoking The Timeline

The patient timeline will not appear on the screen of the user's workstation display, until the user puts focus on a patient in one of the patient lists. When the patient timeline is invoked it will appear in a one-year (default) view. The patient timeline display can be closed by clicking the “x” in the top right corner of the box, in accordance with MS Windows convention.
3.3.1 Function: Ability to invoke patient timeline
   3.3.1.1 By placing focus on a patient's name in a displayed list
   3.3.1.2 The patient timeline is hidden until invoked
3.3.2 Function: Ability to close the patient timeline display
   3.3.2.1 The patient timeline display can be closed by clicking the “x” in the top right corner of the screen, or by removing focus from the patient.
   3.3.2.2 The patient timeline for a given patient is closed, when the Timeline for a different patient is invoked
3.3.3 Function: Patient timeline default view will be one year.
3.3.4 Function: Ability to post new information when focus is moved to a new patient
3.3.5 Function: Ability to manually update the patient timeline
   3.3.5.1 By clicking the Update button, in the top right corner of the box
   3.3.5.2 The “Last Updated” message will display the date and time when the patient timeline was last refreshed

3.4 Customizing Timeline View

The patient timeline is customizable. Checkboxes to the left of the patient timeline allows timeframes to be selected, ranging from one-week to “All events” views. Another set of checkboxes allows the user to filter the types of records that the patient timeline displays. Arrows on each side of the patient timeline allow the user to scroll through the patient timeline; if the user clicks on a particular month, the selected month will expand to fill the patient timeline with a view of that one-month only.
3.4.1 Function: Ability to adjust the timeframe
   3.4.1.1 Checkboxes to left of the patient timeline allow timeframe changes
      3.4.1.1.1 Week—the patient timeline shows a one-week view
      3.4.1.1.2 Month—the patient timeline shows a one-month view
      3.4.1.1.3 Year—the patient timeline shows a one-year view
      3.4.1.1.4 Two Years—the patient timeline shows a two-year view
      3.4.1.1.5 All Events (default view)—the patient timeline shows all events.
   3.4.1.2 Procedure Checkboxes to the left of the patient timeline allow the user to specify which procedures will be displayed on the patient timeline
      3.4.1.2.1 More than one procedure type can be selected simultaneously
      3.4.1.2.2 Patient timeline defaults to ALL procedures
      3.4.1.2.3 Checkbox choices:
         3.4.1.2.3.1 Echo—echo studies display
         3.4.1.2.3.2 Cath—cath studies display
         3.4.1.2.3.3 ECG—ECGs display
         3.4.1.2.3.4 Nuc—Nuclear Med studies display
         3.4.1.2.3.5 EP—EP studies display
         3.4.1.2.3.6 PV—Peripheral vascular studies display
         3.4.1.2.3.7 ALL (default)—all of the above studies display
   3.4.1.3 Checkboxes to the left of the patient timeline allow the user to filter by Procedures or All Data (refer to 3.2.2)
   3.4.1.4 Arrows on each side of patient timeline allow scrolling to a desired time period. Clicking either arrow will move the patient timeline forward or backward by one timeframe increment. Thus, if the month of June is displayed and the right arrow is clicked, the patient timeline will advance to the month of July. If the third week in June is displayed and the left arrow is clicked, the second week in June will be displayed.
   3.4.1.5 Click on desired month to view only that month (expanded to fill patient timeline)

3.5 Event Summary (see FIG. 2)

An Event Summary is displayed as a pop-up balloon/window, that contains a brief description of the selected event in the patient timeline. It is invoked when the user hovers the mouse pointer over an event marker.
3.5.1 Function: Ability to view a summary of a procedure
   3.5.1.1 Hovering the mouse pointer over an event marker displays a pop-up balloon (in the manner of a Windows Tool Tip) that contains procedure information
      3.5.1.1.1 Patient Name
      3.5.1.1.2 Type of Procedure
      3.5.1.1.3 Date of Procedure
      3.5.1.1.4 Performing Physician
      3.5.1.1.5 Procedure ID (case number)
      3.5.1.1.6 Conclusions
      3.5.1.1.7 Recommendations
   3.5.1.2 Only one pop-up balloon is displayed at a time
   3.5.1.3 When the cursor leaves the boundary of the event marker, its associated pop-up balloon disappears.

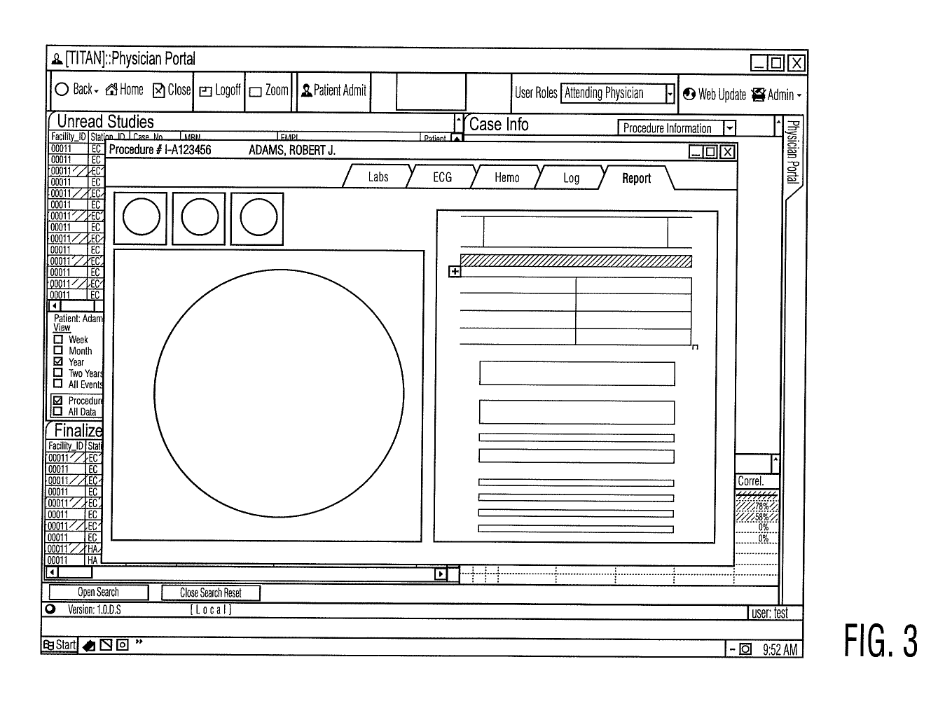

3.6 Procedure Report Review (see FIG. 3)

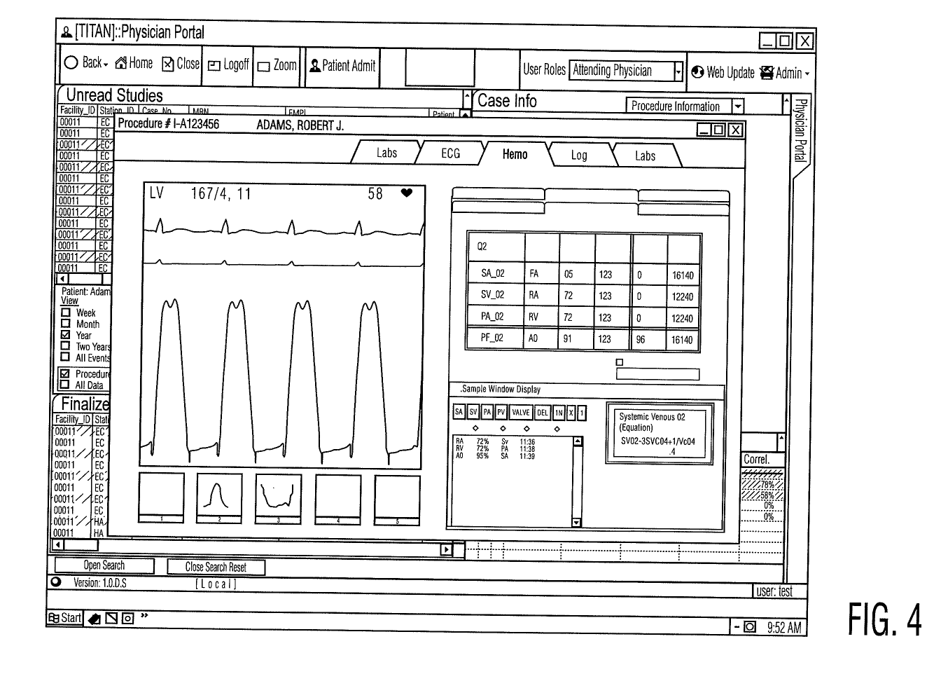

The user can view all procedure-related data, by double-clicking on the event marker, which opens and displays the report of the procedure for review in a floating window. More than one procedure report may be opened at the same time, and each includes identifying information displayed prominently at the top of its window. Tabs within the displayed procedure report window index available information into different categories for easy navigation.
3.6.1 Function: Ability to access procedure-related data for review
   3.6.1.1 By double-clicking on an event marker
   3.6.1.2 More than one procedure report window may be open at a time
      3.6.1.2.1 If multiple procedure report windows are open, they will overlap
      3.6.1.2.2 Identifying information will be viewable at the top of each procedure report window
3.6.2 Function: Tabs are used to index procedure-related data into different categories
   3.6.2.1 Tabs will include the following labels:
      3.6.2.1.1 Report
         3.6.2.1.1.1 View physician's report
         3.6.2.1.1.2 View images from the study
      3.6.2.1.2 Log
         3.6.2.1.2.1 View procedure log
      3.6.2.1.3 Hemo
         3.6.2.1.3.1 View waveforms and hemodynamic data (see FIG. 4)
      3.6.2.1.4 ECG
         3.6.2.1.4.1 View ECG waveform and findings which are imported as PDF file
      3.6.2.1.5 Labs
         3.6.2.1.5.1 View lab values
3.6.3 Function: Window closes with “X” button in upper right part of window

What is claimed:

1. A bar-configured timeline display for a graphical user interface, wherein said interface displays information representative of a patient's medical history in the form of one or more condensed text, event descriptors, each of which identifies a medical procedure or event performed on said patient, and which are positioned, as to time of occurrence, along time increments into which the displayed patient timeline has been chronologically divided, so as to enable a user to see at a glance every event a particular patient has had over the duration of the said patient timeline.

2. The patient timeline display according to claim 1, wherein said patient timeline display is operative, in response to an event descriptor being invoked by a user, to generate a bubble that is linked to said invoked event descriptor, and contains detailed information relating to the selected procedure/event performed on said patient.

3. The patient timeline display according to claim 2, wherein said detailed information includes date and type of procedure, performing physicians, conclusion, and recommendations where appropriate.

4. The patient timeline display according to claim 1, wherein said patient timeline display is operative, in response to an event descriptor being invoked by a user, to open a procedure results window containing tabs that index procedure-related information into separate different categories, including, but not limited to, laboratory analyses, procedure logs, procedure reports, medications, history and physical data, admissions, hospital emergency department visits, physician's office visits, and electrocardiograms.

5. The patient timeline display according to claim 1, wherein said patient timeline display is operative to display said event descriptors as color-coded markers, in accordance with the identified types of medical procedures or events performed on said patient.

6. A method of displaying a graphical user interface comprising:
storing information in a database;
retrieving the information from the database;
displaying a graphical user interface, wherein the graphical user interface comprises a bar-configured patient timeline display that includes information representative of a patient's medical history in the form of one or more condensed text event descriptors, and wherein each descriptor identifies a medical procedure or event performed on said patient positioned, based on time of occurrence, along time increments into which the displayed patient timeline has been chronologically divided, so as to enable a user to see at a glance every event a particular patient has had over the duration of the patient timeline.
